(19) United States
(12) Patent Application Publication
(10) Pub. No.: US 2025/0320404 A1
(43) Pub. Date: Oct. 16, 2025

(54) METHODS FOR STABILIZING SUBTERRANEAN FORMATIONS

(71) Applicants: Saudi Arabian Oil Company, Dhanran (SA); King Fahd University of Petroleum and Minerals, Dhahran (SA)

(72) Inventors: Manar AlAhmari, Dhahran (SA); Abdulmohsen Alhumam, Dhahran (SA); Mohamed A. Mahmoud, Dammam (SA)

(73) Assignees: Saudi Arabian Oil Company, Dhahran (SA); King Fahd University of Petroleum and Minerals, Dhahran (SA)

(21) Appl. No.: 18/631,863

(22) Filed: Apr. 10, 2024

(51) Int. Cl. C09K 8/575; E02D 3/12

(52) U.S. Cl. CPC C09K 8/5758; E02D 3/12; C09K 2208/24

(57) ABSTRACT

Described herein are methods for stabilizing a subterranean formation. The method may include introducing urea into a subterranean formation, wherein the subterranean formation includes sand, and wherein the subterranean formation includes a calcium salt, and introducing an amylase into the subterranean formation, wherein the amylase hydrolyzes the urea to form ammonium carbonate, and calcium in the calcium salt reacts with carbonate in the ammonium carbonate to form a calcium carbonate precipitate.

### FIELD

Embodiments of the present disclosure generally relate to natural resource extraction and, more specifically, to subterranean natural resource extraction.

### BACKGROUND

Oil and gas production and processing facilities are continually growing to keep up with the rising demand for energy throughout the world. One challenge in subterranean oil and gas extraction is sand production in a well. The sand production increases the drag force and in situ stress. It causes sand particles to move from reservoirs to the wellbore and come into the production stream. Many of the oil and gas reservoirs have poor sand consolidation and millions of dollars are being spent on sand production controlling technologies. Some issues are brought on by sand production, such as downhole or wellhead equipment erosion and plugging, formation rock subsidence, and wall demolition. Additionally, sand production may result in a reduction in the productivity index, increased maintenance costs, stimulation of operational issues, equipment damage, and other issues about health, safety, and the environment.

### SUMMARY

Sand production during oil and gas extraction poses a severe challenge to the oil and gas industry, as it causes erosion of pipelines and valves, damages the pumps, and ultimately decreases production. Described herein are methods that may be utilized to mitigate sand production from wells by utilizing amylase. It has been discovered that amylase can be injected into subterranean formation to ultimately form calcium carbonate, which may stabilize the subterranean formation and mitigate sand production.

According to one or more embodiments, a subterranean formation may be stabilized may a method comprising introducing urea into a subterranean formation, wherein the subterranean formation comprises sand, and wherein the subterranean formation comprises a calcium salt. The method may further comprise introducing an amylase into the subterranean formation, wherein the amylase hydrolyzes the urea to form ammonium carbonate, and calcium in the calcium salt reacts with carbonate in the ammonium carbonate to form a calcium carbonate precipitate.

It is to be understood that both the preceding general description and the following detailed description describe various embodiments and are intended to provide an overview or framework for understanding the nature and character of the claimed subject matter. Additional features and advantages of the embodiments will be set forth in the detailed description and, in part, will be readily apparent to persons of ordinary skill in the art from that description, which includes the accompanying drawings and claims, or recognized by practicing the described embodiments. The drawings are included to provide a further understanding of the embodiments and, together with the detailed description, serve to explain the principles and operations of the claimed subject matter. However, the embodiments depicted in the drawings are illustrative and exemplary in nature, and not intended to limit the claimed subject matter.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1 graphically depicts precipitation percentage as a function of CaCl₂ concentration in evaluated samples, according to one or more embodiments described herein;

FIG. 2 graphically depicts precipitation percentage as a function of CaCl₂ to MgCl₂ in evaluated samples, according to one or more embodiments described herein;

FIG. 3 graphically depicts precipitation percentage as a function of alpha amylase enzyme volume in evaluated samples, according to one or more embodiments described herein;

FIG. 4 graphically depicts precipitation percentage as a function of pH in evaluated samples, according to one or more embodiments described herein;

FIG. 5 graphically depicts precipitation percentage as a function xanthan gum (XG) concentration and temperature in evaluated samples, according to one or more embodiments described herein;

FIG. 6 graphically depicts mass loss as a function of temperature concentration of potassium hydroxide (KOH) in evaluated samples, according to one or more embodiments described herein; and

FIG. 7 illustrates an FTIR analysis for samples having varying KOH concentration in evaluated samples, according to one or more embodiments described herein.

### DETAILED DESCRIPTION

Embodiments of the present disclosure are directed to methods for stabilizing a subterranean formation. According to embodiments of the methods for stabilizing the subterranean formation, urea may be introduced into the subterranean formation, where the subterranean formation includes sand and calcium salt. The method may further comprise introducing amylase into the subterranean formation. As described herein, the components in the subterranean formation may react to form calcium carbonate precipitate. Such formation of calcium carbonate precipitate may serve to stabilize the subterranean formation whereby stiffness and strength to the loose sand is generally improved. By increasing the stiffness and strength of the lose sand, sand production during oil and gas extraction is generally reduced, which thereby increases oil and gas production and reduces damage to pumps and erosion of pipelines and valves.

As described herein, subterranean formations may be stabilized by implementing the methods disclosed herein. A subterranean formation is the fundamental unit of lithostratigraphy. As used in the present disclosure, the term “subterranean formation” may refer to a body of rock that is sufficiently distinctive and continuous from the surrounding rock bodies that the body of rock can be mapped as a distinct entity. A subterranean formation may be sufficiently homogenous to form a single identifiable unit containing similar geological properties throughout the subterranean formation, including, but not limited to, porosity and permeability. A single subterranean formation may include different regions, where some regions include hydrocarbons and others do not.

In one or more embodiments, the subterranean formation into which urea is introduced includes sand. The sand may be naturally occurring, or may be the result of drilling. The subterranean formation may, in some embodiments, also include silt, clay, or combinations thereof.

According to embodiments, the method may include introducing urea, which has the formula H₂N(CO)NH₂, into a subterranean formation. For example, the urea may be in a solution that is injected into the subterranean formation. The injecting may be forced by a pump, or may be any other suitable means for injecting the urea downhole.

The subterranean formation may further include a calcium salt. The calcium salt may occur naturally in the subterranean formation, or the calcium salt may be introduced to the subterranean formation from the surface. In embodiments where the calcium salt is introduced into the subterranean formation, the calcium salt may be in a solution that is injected into the subterranean formation, similarly to the injection of the urea. In some embodiments, the subterranean formation may be saturated with the calcium salt, i.e. the calcium salt may be introduced until the subterranean formation is unable to absorb more calcium salt. In one or more embodiments, the calcium salt may, without limitation, be calcium chloride, calcium nitrate, or a combination thereof.

In some embodiments, the ratio of urea to calcium salt in the downhole environment may be from 1:10 to 10:1, from 1:5 to 10:1, from 1:4 to 10:1, from 1:3 to 10:1, from 1:2 to 10:1, from 1:1 to 10:1, from 1:10 to 5:1, from 1:5 to 5:1, from 1:4 to 5:1, from 1:3 to 5:1, from 1:2 to 5:1, from 1:1 to 5:1, from 1:10 to 4:1, from 1:5 to 4:1, from 1:4 to 4:1, from 1:3 to 4:1, from 1:2 to 4:1, from 1:1 to 4:1, from 1:10 to 3:1, from 1:5 to 3:1, from 1:4 to 3:1, from 1:3 to 3:1, from 1:2 to 3:1, from 1:1 to 3:1, 1:10 to 2:1, from 1:5 to 2:1, from 1:4 to 2:1, from 1:3 to 2:1, from 1:2 to 2:1, from 1:1 to 2:1, from 1:10 to 1:1, from 1:5 to 1:1, from 1:4 to 1:1, from 1:3 to 1:1, or from 1:2 to 1:1. Without being bound by theory, this ratio of urea to calcium salt is believed to enhance stabilization of the subterranean formation per the methods described herein.

The method may further include introducing one or more amylase compounds into the subterranean formation. For example, the amylase may be injected into the subterranean formation in a solution. The amylase may hydrolyze the urea to form ammonium carbonate. The calcium in the calcium salt may react with carbonate in the ammonium carbonate to form a calcium carbonate precipitate. The calcium carbonate precipitate may include calcite, aragonite, sylvite, or combinations thereof. Such precipitation of calcium carbonate may stabilize the subterranean formation as described herein, mitigating sand production.

As described herein, according to embodiments, amylase may be introduced into the subterranean formation. In general, and is understood by those skilled in the art, “amylase” or “amylase enzyme” refers to any enzyme that catalyzes the hydrolysis of starch. The amylases utilized in the presently disclosed processes are generally effective to hydrolyze urea. One or more amylase enzymes may be utilized. Examples of suitable amylase enzymes include, without limitation, alpha amylase (International Union of Biochemistry and Molecular Biology Enzyme Nomenclature Number (EC) 3.2.1.1), beta amylase (EC 3.2.1.2), glucoamylase (EC 3.2.1.3), oligo-1,6-glucosidase (EC 3.2.1.10), alpha glucosidase (EC 3.2.1.20), amylo-1,6-glucosidase (EC 3.2.1.33), pullulanase (EC 3.2.1.41), cyclomaltodextrinase (EC 3.2.1.54), glucan-1,4-α-maltotetraohydrolase (EC 3.2.1.60), isoamylase (EC 3.2.1.68), glucan-1,4-alpha-maltohexaohydrolase (EC 3.2.1.98), glucan-1,4-alpha-maltotriohydrolase (EC 3.2.1.116), glucan-1,4-alpha-maltohydrolase (EC 3.2.1.133), neopullulanase (EC 3.2.1.135), 4-alpha-D-glucanotrehalosetrehalohydrolase (EC 3.2.1.141), branching enzyme (EC 2.4.1.18), cyclomaltodextringlucanotransferase (EC 2.4.1.19), 4-alpha-glucanotransferase (EC 2.4.1.25), and 4-alpha-glucan 1-alpha-D-glucosylmutase (EC 5.4.99.15). In some embodiments, the amylase consists of alpha amylase. The amylases utilized in the methods described herein can be obtained from plants, animals, and microorganisms.

As is described herein, the presently disclosed embodiments that utilize amylases may have one or more advantages over conventional means for stabilizing subterranean formation. For example, conventional techniques of stabilization may typically uses a urease enzyme derived from jack beans. The precipitation of calcite through enzymatic activity is very much based on enzyme type, purity, and reactivity. To achieve a high-purity enzyme, the main source of the urease used as a commercial product is jack bean, which needs to be refined. If stabilization techniques are used on a large scale, this purification may be prohibitively expensive. On the other hand, amylase enzymes are one of the main enzymes that are widely employed in the industry which is a great incentive to utilize it for the petroleum industry. Alpha amylases account for 33% of the global enzyme output.

In some embodiments, the amylase may be introduced to the subterranean formation as a solution. The solution may comprise from 0.1 wt. % to 50 wt. %, from 0.5 wt. % to 50 wt. %, from 1 wt. % to 50 wt. %, from 5 wt. % to 50 wt. %, from 10 wt. % to 50 wt. %, from 15 wt. % to 50 wt. %, from 20 wt. % to 50 wt. %, from 0.1 wt. % to 30 wt. %, from 0.5 wt. % to 30 wt. %, from 1 wt. % to 30 wt. %, from 5 wt. % to 30 wt. %, from 10 wt. % to 30 wt. %, from 15 wt. % to 30 wt. %, from 20 wt. % to 30 wt. %, from 0.1 wt. % to 25 wt. %, from 0.5 wt. % to 25 wt. %, from 1 wt. % to 25 wt. %, from 5 wt. % to 25 wt. %, from 10 wt. % to 25 wt. %, from 15 wt. % to 25 wt. %, from 20 wt. % to 25 wt. %, from 0.1 wt. % to 20 wt. %, from 0.5 wt. % to 20 wt. %, from 1 wt. % to 20 wt. %, from 5 wt. % to 20 wt. %, from 10 wt. % to 20 wt. %, from 15 wt. % to 20 wt. %, from 0.1 wt. % to 15 wt. %, from 0.5 wt. % to 15 wt. %, from 1 wt. % to 15 wt. %, from 5 wt. % to 15 wt. %, from 10 wt. % to 15 wt. %, from 0.1 wt. % to 10 wt. %, from 0.5 wt. % to 10 wt. %, from 1 wt. % to 10 wt. %, or from 5 wt. % to 10 wt. % amylase based on the total weight of the solution. Without being bound by theory, this concentration is believed to enhance stabilization of the subterranean formation.

In various embodiments, the subterranean formation may also include a magnesium salt. The magnesium salt may occur naturally in the subterranean formation, or the magnesium salt may be introduced to the subterranean formation. In embodiments where the magnesium salt is introduced into the subterranean formation, the magnesium salt may be in a solution that is injected into the subterranean formation. The magnesium salt may be introduced before, after the urea, after the urea, simultaneously with the urea, or even if the same solution as the urea. In one or more embodiments, the magnesium salt may be magnesium nitrate, magnesium chloride, and/or combinations thereof. Without being bound by theory, it is believed that magnesium in the magnesium salt may react with carbonate in the ammonium carbonate to form a magnesium carbonate precipitate. In one or more embodiments, the magnesium chloride precipitate may be dolomite.

The ratio of the calcium salt to the magnesium salt in the subterranean formation may be from 1:10 to 10:1, from 1:5 to 10:1, from 1:4 to 10:1, from 1:3 to 10:1, from 1:2 to 10:1, from 1:1 to 10:1, from 1:10 to 5:1, from 1:5 to 5:1, from 1:4 to 5:1, from 1:3 to 5:1, from 1:2 to 5:1, from 1:1 to 5:1, from 1:10 to 4:1, from 1:5 to 4:1, from 1:4 to 4:1, from 1:3 to 4:1, from 1:2 to 4:1, from 1:1 to 4:1, from 1:10 to 3:1, from 1:5 to 3:1, from 1:4 to 3:1, from 1:3 to 3:1, from 1:2 to 3:1, from 1:1 to 3:1, 1:10 to 2:1, from 1:5 to 2:1, from 1:4 to 2:1, from 1:3 to 2:1, from 1:2 to 2:1, from 1:1 to 2:1, from 1:10 to 1:1, from 1:5 to 1:1, from 1:4 to 1:1, from 1:3 to 1:1, or from 1:2 to 1:1. Without being bound by theory, this ratio is believed to enhance stabilization of the subterranean formation.

In some embodiments, the subterranean formation has an acidic pH, a neutral pH, or a basic pH. Without being bound by theory, pH is believed to play a crucial role in the precipitation of calcite induced by amylase. For example, the amylase enzyme may have an optimal pH range for activity, and the pH of a solution can impact the enzyme activity, which, in turn, can affect the rate of calcite precipitation. If the pH is too low, the enzyme may become denatured, and the activity may decrease, leading to a reduction in the rate of calcite precipitation. On the other hand, if the pH is too high, the concentration of carbonate ions may decrease, which could also limit calcite precipitation. Therefore, without being boing by any theory, it may be important to maintain the pH of the solution within the optimal range to ensure efficient and effective calcite precipitation induced by amylase. pH adjustments may be carried out using buffers, such as sodium bicarbonate, to maintain the desired pH range for the activity of the amylase enzyme. In some embodiments, the subterranean formation may have a pH of from 1 to 14, from 2 to 14, from 3 to 14, from 4 to 14, from 5 to 14, from 6 to 14, from 7 to 14, from 8 to 14, from 9 to 14, from 10 to 14, from 11 to 14, from 12 to 14, 1 to 13, from 2 to 13, from 3 to 13, from 4 to 13, from 5 to 13, from 6 to 13, from 7 to 13, from 8 to 13, from 9 to 13, from 10 to 13, from 11 to 13, from 12 to 13, from 1 to 12, from 2 to 12, from 3 to 12, from 4 to 12, from 5 to 12, from 6 to 12, from 7 to 12, from 8 to 12, from 9 to 12, from 10 to 12, from 1 to 11, from 2 to 11, from 3 to 11, from 4 to 11, from 5 to 11, from 6 to 11, from 7 to 11, from 8 to 11, from 9 to 11, from 10 to 11, from 1 to 10, from 2 to 10, from 3 to 10, from 4 to 10, from 5 to 10, from 6 to 10, from 7 to 10, from 8 to 10, from 9 to 10, from 1 to 9, from 2 to 9, from 3 to 9, from 4 to 9, from 5 to 9, from 6 to 9, from 7 to 9, from 8 to 9, from 1 to 8, from 2 to 8, from 3 to 8, from 4 to 8, from 5 to 8, from 6 to 8, or from 7 to 8 at 25° C. Without being bound by theory, it is believed that the amylase will increase calcite precipitation if the subterranean formation has a basic pH. Furthermore, it is believed that the amylase may increase calcite precipitation at a pH of from 11 to 13, as this pH is high enough that the concentration of carbonate ions will not decrease, but low enough that the enzyme will not become denatured.

The method may be conducted at a temperature of from 0° C. to 100° C., such as from 20° C. to 100° C., from 25° C. to 100° C., from 50° C. to 100° C., from 75° C. to 100° C., from 0° C. to 75° C., from 0° C. to 50° C., from 0° C. to 25° C., or from 0° C. to 20° C. Without being bound by theory, higher temperatures are believed to speed up the rate of reaction but too high of temperatures may lead to amylase denaturization.

The method may further include introducing xanthan gum into the subterranean formation. Without being bound by theory, xanthan gum is believed to act as a stabilizer for the amylase, i.e. the xanthan gum is believed to help the amylase stay in solution. The xanthan gum may have a concentration of from 0.1 g/L to 10 g/L, from 0.5 g/L to 10 g/L, from 1 g/L to 10 g/L, from 2 g/L to 10 g/L, from 0.5 g/L to 5 g/L, from 1 g/L to 5 g/L, from 2 g/L to 5 g/L, from 0.5 g/L to 3 g/L, from 1 g/L to 3 g/L, or from 2 g/L to 3 g/L in the subterranean formation. Without being bound by theory, this concentration is believed to stabilize the amylase in solution.

The method may further include extracting hydrocarbons from the subterranean formation. Without being bound by theory, precipitating the calcium carbonate may consolidate sand, silt, and/or clay in the subterranean formation, and may increase the shear strength of the subterranean formation. The calcium carbonate precipitation may bind sand grains together, and may prevent some sand in the subterranean formation from interacting with and possibly damaging equipment used to extract the hydrocarbons.

### EXAMPLES

The following examples illustrate one or more features of the present disclosure. It should be understood that these examples are not intended to limit the scope of the disclosure or the appended claims in any manner.

### Materials

Urea, calcium chloride, magnesium chloride, potassium hydroxide, and xanthan gum were acquired from Sigma Aldrich. Alpha amylase enzyme was supplied by MN-CHEM Saudi Arabia.

### Example 1

Solution were prepared that included urea, CaCl₂, and alpha amylase. The prepared solutions were then combined according to their mixing percentages and left to catalyze the precipitation reaction in a test tube for 48 hours. After the 48-hour period, the resulting fluid was filtered out and the reaction product that had accumulated in the test tube and on the filter paper was dried for 24 h in an oven at 70° C. Once dried, the total weight of the reaction product was measured, excluding the weight of the test tube and filter paper. The total weight included the CaCO₃ and the other reaction products. By measuring precipitation proportion, the mass of CaCO₃ formed was estimated by determining the theoretical mass of CaCO₃ using Equation (1) and the precipitation ratio according to Equation (2). In Equation (1), C represents the total concentration of the solution expressed as moles of solute per liters of solution (molarity; mol/L), V represents the total volume in the test tube in liters (L), and 100.087 g/mol is the molar mass of CaCO₃.

$$Theoretical Mass of {CaCO}_{3} = 100.087 \frac{g}{mol} \times Concentration \times Volume \qquad Equation ( 1 )$$

$$Precipitation Ratio = \frac{Actual Mass of the Precipitate}{Theoretical Mass of {CaCO}_{3}} \qquad Equation ( 2 )$$

The collected solids precipitates were analyzed by performing several analytical techniques including Thermogravimetric analysis (TGA), Fourier transform infrared spectroscopy (FTIR), and X-ray diffraction (XRD) for their composition and microstructure. The used instruments were Thermogravimetric analysis (TGA) by PerkinElmer® TGA 8000, Fourier-transform infrared spectroscopy (FTIR) by Bruker INVENIO® S FT-IR spectrometer, XRD from Panalytical Empyrean diffractometer.

TGA is a thermal investigation technique that monitors the mass loss of material as temperature increases. In this study, TGA from Perkin Elmer (TGA8000) was employed to track the weight loss of a precipitated product as the temperature was raised to 900° C., with nitrogen gas flowing at a rate of 20 mL/min. The use of nitrogen gas created an inert environment that acted as an insulator to protect the sample from rapid combustion. During the TGA analysis, approximately 10 mg of the sample was accurately measured and loaded onto the TGA balance, and a temperature schedule was applied. The in-built software calculated the weight change in response to the temperature rise.

FTIR spectroscopy plays a primary role in material analysis, and it is applied to identify the functional groups and the composition of the precipitated product. FTIR involves exposing a sample to infrared radiation and plotting the amount of radiation absorbed at various wavelengths to produce an FTIR spectrum. The peaks and dips in the spectrum reveal the unique absorption patterns of each chemical bond and functional group in the sample to identify and distinguish between different substances and gain insights into their chemical composition.

XRD was applied to identify the product composition and compounds formed during precipitation. When a substance is exposed to X-rays and the resulting diffraction pattern is analyzed, valuable information about the arrangement of atoms within its crystal lattice can be obtained. This information is crucial for determining the precise crystal structure of the material. By comparing the diffraction pattern of a sample to a database of known patterns, we can identify the various compounds present in the sample with high accuracy.

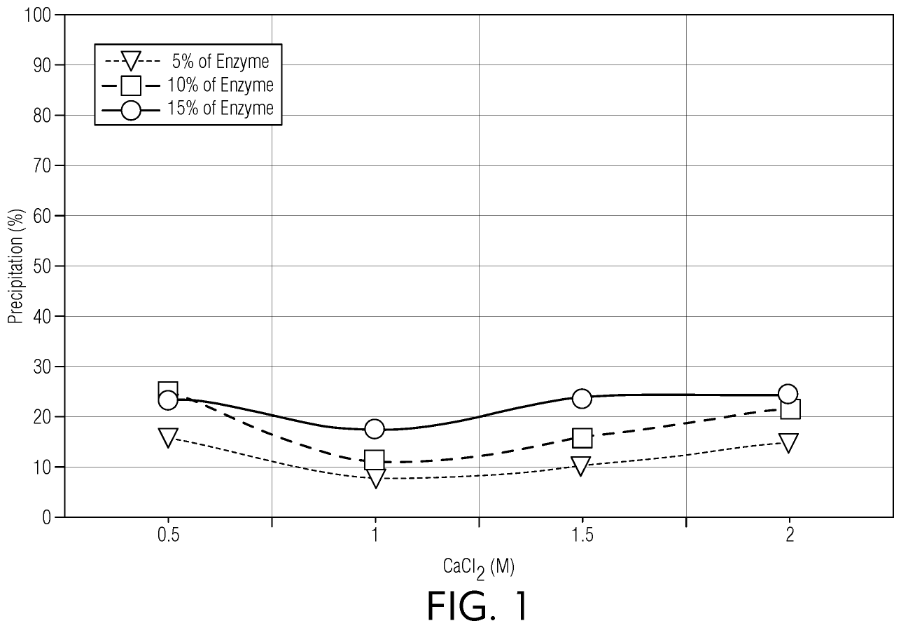

FIG. 1 illustrates the impact of alpha amylase enzyme concentration on precipitation product at varying molar concentrations of CaCl₂ for Samples 1-12, as shown in Table 1. Specifically, the effect of CaCl₂ was studied on three different alpha amylase enzyme concentrations (5%, 10%, and 15%), with CaCl₂ concentration ranging from 0.5 M to 2 M. Results indicated that higher alpha amylase enzyme concentration led to greater precipitation at a given CaCl₂ molar concentration. As alpha amylase enzyme concentration increased, so did the amount of calcium carbonate precipitation, highlighting the positive relationship between enzyme concentration and precipitation.

TABLE 1
Formulations of Samples 1-12

| Sample | Urea | CaCl₂ | Enzyme | Temperature |
|---|---|---|---|---|
| No. | (M) | (M) | wt. % | (° C.) |
| 1 | 1 | 0.5 | 5 | 25 |
| 2 | 1 | 0.5 | 10 | 25 |
| 3 | 1 | 0.5 | 15 | 25 |
| 4 | 1 | 1 | 5 | 25 |
| 5 | 1 | 1 | 10 | 25 |
| 5 | 1 | 1 | 15 | 25 |
| 7 | 1 | 1.5 | 5 | 25 |
| 8 | 1 | 1.5 | 10 | 25 |
| 9 | 1 | 1.5 | 15 | 25 |
| 10 | 1 | 2 | 5 | 25 |
| 11 | 1 | 2 | 10 | 25 |
| 12 | 1 | 2 | 15 | 25 |

Furthermore, the change in CaCl₂ concentration at a particular alpha amylase enzyme concentration also influenced precipitation mass. In general, increasing the amount of CaCl₂ led to higher precipitation percentages. However, at 15% alpha amylase enzyme concentration, a change in CaCl₂ concentration from 1.5 M to 2 M did not result in significant changes. Conversely, lower alpha amylase enzyme concentrations exhibited a rising trend in precipitation with increasing CaCl₂ concentration.

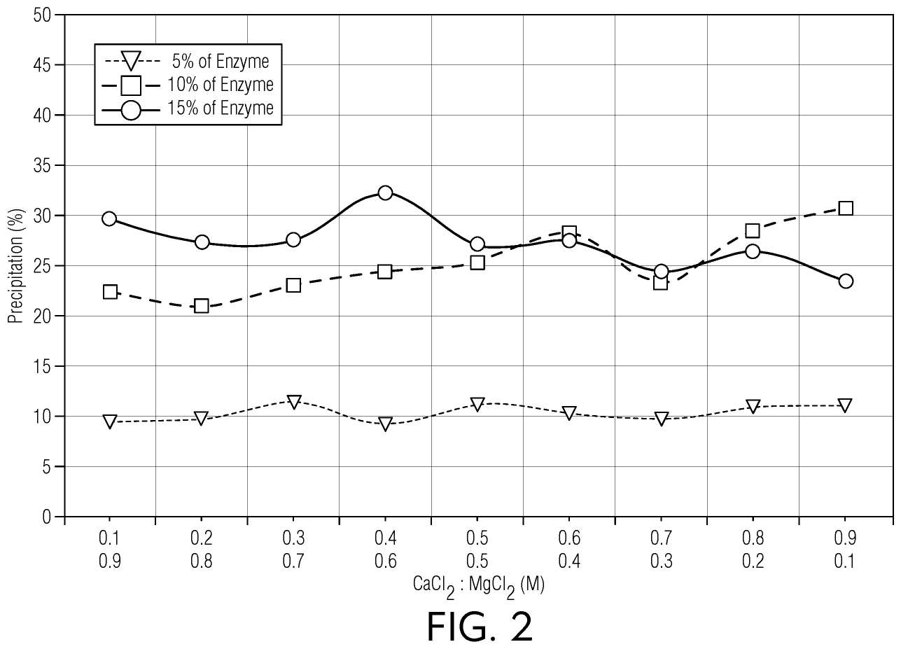

FIG. 2 illustrates the combined effect of CaCl₂ and MgCl₂ at different molar concentrations on various alpha amylase enzyme concentrations (5%, 10%, and 15%) for Samples 13-39 shown in Table 2. Results showed a similar trend to that of CaCl₂, but with higher precipitations observed. As alpha amylase enzyme concentration increased, so did the amount of precipitation, except at the highest alpha amylase enzyme concentration, where a change in the CaCl₂:MgCl₂ molar ratio led to decreased precipitation. Notably, at 10% alpha amylase enzyme concentration, the trend was reversed, resulting in increased precipitation. At 5% alpha amylase enzyme concentration, precipitation remained at 10% and did not vary.

TABLE 2
Formulations of Samples 13-39

| Sample | Urea | CaCl₂ | MgCl₂ | Enzyme | Temperature |
|---|---|---|---|---|---|
| No. | (M) | (M) | (M) | wt. % | (° C.) |
| 13 | 1 | 0.9 | 0.1 | 5 | 25 |
| 14 | 1 | 0.9 | 0.1 | 10 | 25 |
| 15 | 1 | 0.9 | 0.1 | 15 | 25 |
| 16 | 1 | 0.8 | 0.2 | 5 | 25 |
| 17 | 1 | 0.8 | 0.2 | 10 | 25 |
| 18 | 1 | 0.8 | 0.2 | 15 | 25 |
| 19 | 1 | 0.7 | 0.3 | 5 | 25 |
| 20 | 1 | 0.7 | 0.3 | 10 | 25 |
| 21 | 1 | 0.7 | 0.3 | 15 | 25 |
| 22 | 1 | 0.6 | 0.4 | 5 | 25 |
| 23 | 1 | 0.6 | 0.4 | 10 | 25 |
| 24 | 1 | 0.6 | 0.4 | 15 | 25 |
| 25 | 1 | 0.5 | 0.5 | 5 | 25 |
| 26 | 1 | 0.5 | 0.5 | 10 | 25 |
| 27 | 1 | 0.5 | 0.5 | 15 | 25 |
| 28 | 1 | 0.4 | 0.6 | 5 | 25 |
| 29 | 1 | 0.4 | 0.6 | 10 | 25 |
| 30 | 1 | 0.4 | 0.6 | 15 | 25 |
| 31 | 1 | 0.3 | 0.7 | 5 | 25 |
| 32 | 1 | 0.3 | 0.7 | 10 | 25 |
| 33 | 1 | 0.3 | 0.7 | 15 | 25 |
| 34 | 1 | 0.2 | 0.8 | 5 | 25 |
| 35 | 1 | 0.2 | 0.8 | 10 | 25 |
| 36 | 1 | 0.2 | 0.8 | 15 | 25 |
| 37 | 1 | 0.1 | 0.9 | 5 | 25 |
| 38 | 1 | 0.1 | 0.9 | 10 | 25 |
| 39 | 1 | 0.1 | 0.9 | 15 | 25 |

Overall, these results suggest that increasing alpha amylase enzyme concentration at a particular concentration of CaCl₂ can lead to higher precipitation levels, with the highest precipitation obtained at 15% alpha amylase enzyme concentration.

The precipitation findings showed that 15% alpha amylase enzyme concentration yielded the highest CaCO₃ precipitation and that (0.6:0.4) mol was the most effective molar ratio in terms of yielding the highest precipitation ratio therefore these concentrations are used for the subsequent tests. Adding MgCl₂ to the reaction mixture improves the precipitation efficiency and increases the precipitation mass of CaCO₃. Adding MgCl₂ in EICP can lead to dolomite minerals forming, which have a higher precipitation mass than pure calcium carbonate.

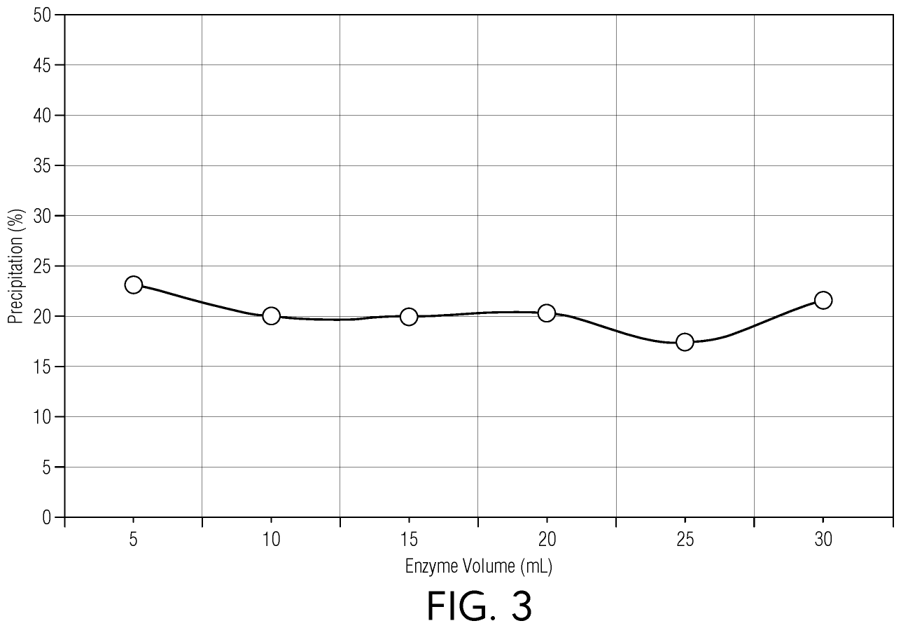

Further, alpha amylase's volume to the EICP solution's volume ratio was investigated. It was observed that adding more volume of alpha amylase enzymes did not have a discernible impact on precipitation as shown in FIG. 3. Simply increasing alpha amylase enzyme volume may not change the precipitation as the solution is over-saturated with excessive alpha amylase enzymes with little or no substrate available. Hence, the excess alpha amylase enzymes may not play any role in the reaction.

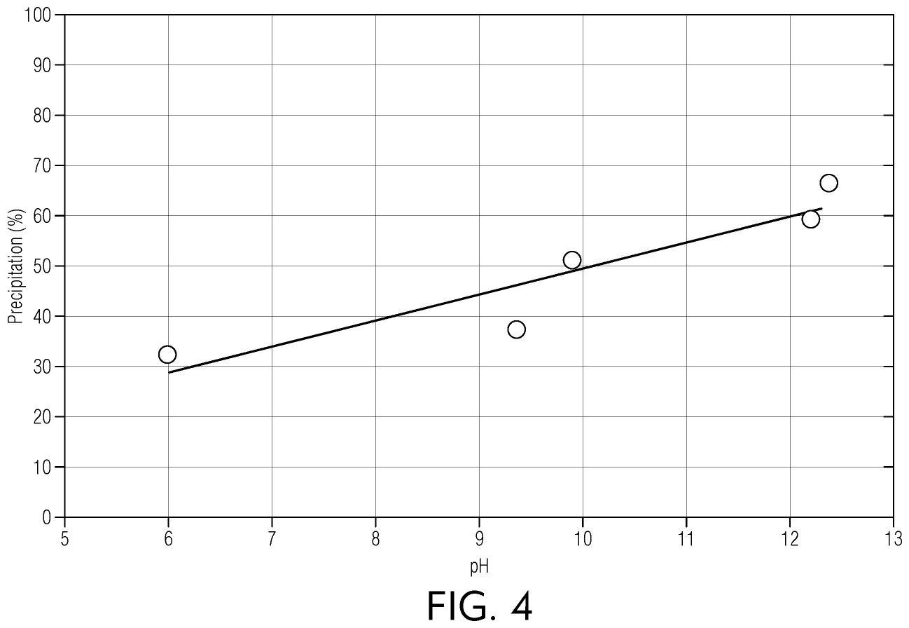

The influence of solution pH on precipitation is illustrated in FIG. 4. pH was influenced using potassium hydroxide (KOH) for Samples 40-45, as shown in Table 3. There was a correlation between the increase in pH and the increase in precipitation. Here, the precipitation percent was increased with an increase in pH with 12.4 producing the highest amount of precipitation (65%).

TABLE 3
Formulations of Samples 40-45

| Sam- | | | | | Temper- | EICP | Enzyme |
|---|---|---|---|---|---|---|---|
| ple | Urea | CaCl₂ | MgCl₂ | Enzyme | ature | Volume | Volume |
| No. | (M) | (M) | (M) | wt. % | (° C.) | (mL) | (mL) |
| 40 | 1 | 0.6 | 0.4 | 15 | 25 | 25 | 5 |
| 41 | 1 | 0.6 | 0.4 | 15 | 25 | 25 | 10 |
| 42 | 1 | 0.6 | 0.4 | 15 | 25 | 25 | 15 |
| 43 | 1 | 0.6 | 0.4 | 15 | 25 | 25 | 20 |
| 44 | 1 | 0.6 | 0.4 | 15 | 25 | 25 | 25 |
| 45 | 1 | 0.6 | 0.4 | 15 | 25 | 25 | 30 |

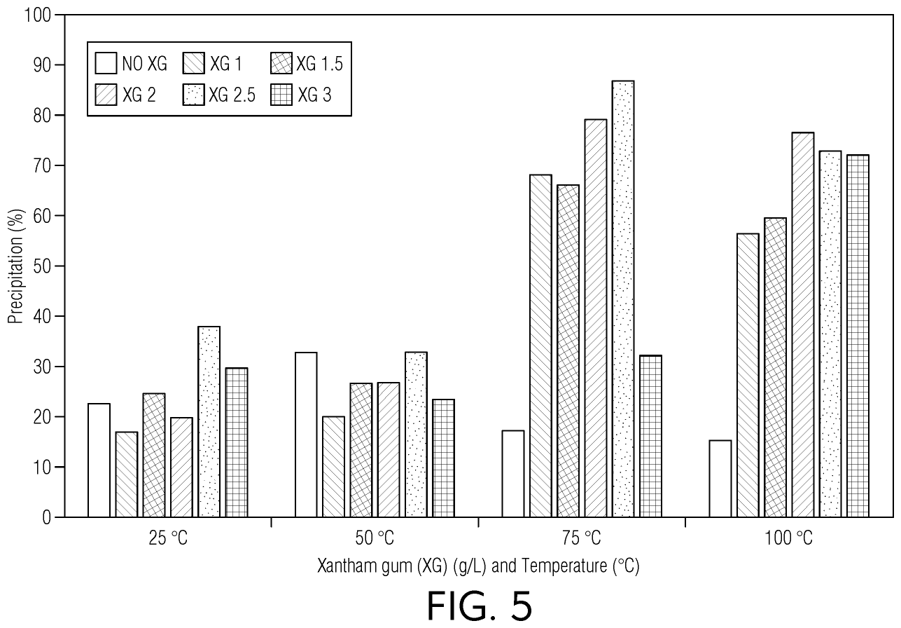

The effect of temperature and xanthan gum on precipitation is depicted in FIG. 5 for Samples 46-65, as shown in Table 4. A total of four distinct temperatures (25, 50, 75, and 100° C.) were used for the precipitation test. Five different concentrations of the xanthan gum (1, 1.5, 2, 2.5, and 3) g/L were evaluated on precipitation. The temperature was found to be affected the precipitation %. Precipitation varied with temperature in the base case. The difference was minimal from 25° C. to 50° C. The difference was noticeable around 75° C. The precipitation dropped at 100° C., which may have been caused by the thermal degradation or inactiveness of the alpha amylase enzymes. Changes in precipitate concentration were brought about by adding more xanthan gum to the solution. With 2.5 g/L of xanthan gum, the maximum precipitation (87%) was produced at 75° C. The measured precipitation includes the dry polymer and other reaction products included.

TABLE 4
Formulations for Samples 46-65

| | | | | | | Xanthan |
|---|---|---|---|---|---|---|
| Sample | Urea | CaCl₂ | MgCl₂ | Enzyme | Temperature | Gum |
| No. | (M) | (M) | (M) | wt. % | (° C.) | (g/L) |
| 46 | 1 | 0.6 | 0.4 | 15 | 25 | 1 |
| 47 | 1 | 0.6 | 0.4 | 15 | 25 | 1.5 |
| 48 | 1 | 0.6 | 0.4 | 15 | 25 | 2 |
| 49 | 1 | 0.6 | 0.4 | 15 | 25 | 2.5 |
| 50 | 1 | 0.6 | 0.4 | 15 | 25 | 3 |
| 51 | 1 | 0.6 | 0.4 | 15 | 50 | 1 |
| 52 | 1 | 0.6 | 0.4 | 15 | 50 | 1.5 |
| 53 | 1 | 0.6 | 0.4 | 15 | 50 | 2 |
| 54 | 1 | 0.6 | 0.4 | 15 | 50 | 2.5 |
| 55 | 1 | 0.6 | 0.4 | 15 | 50 | 3 |
| 56 | 1 | 0.6 | 0.4 | 15 | 75 | 1 |
| 57 | 1 | 0.6 | 0.4 | 15 | 75 | 1.5 |
| 58 | 1 | 0.6 | 0.4 | 15 | 75 | 2 |
| 59 | 1 | 0.6 | 0.4 | 15 | 75 | 2.5 |
| 60 | 1 | 0.6 | 0.4 | 15 | 75 | 3 |
| 61 | 1 | 0.6 | 0.4 | 15 | 100 | 1 |
| 62 | 1 | 0.6 | 0.4 | 15 | 100 | 1.5 |
| 63 | 1 | 0.6 | 0.4 | 15 | 100 | 2 |
| 64 | 1 | 0.6 | 0.4 | 15 | 100 | 2.5 |
| 65 | 1 | 0.6 | 0.4 | 15 | 100 | 3 |

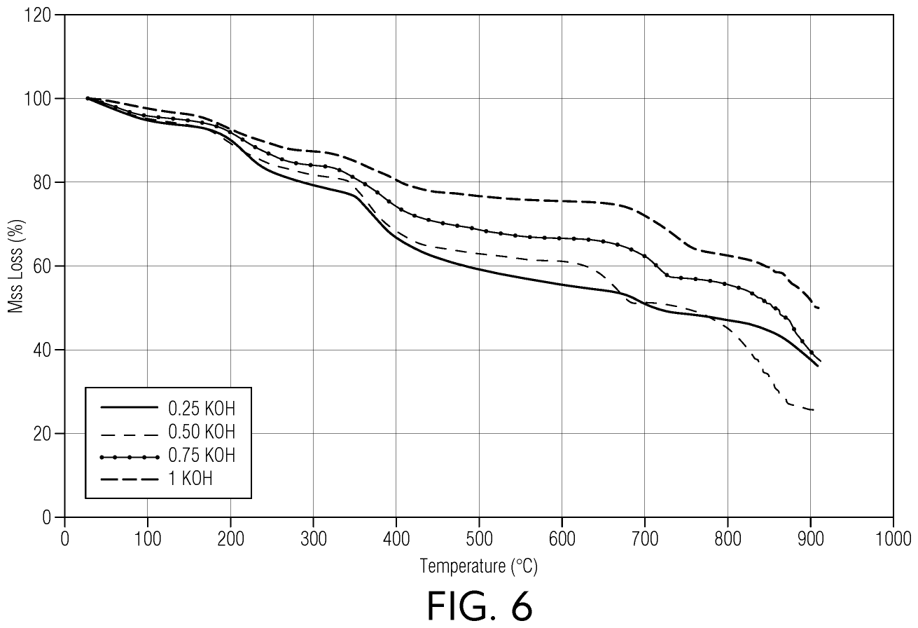

The TGA analysis was conducted on the precipitate to investigate their thermal stability. FIG. 6 demonstrated the TGA of four different samples which differ in pH. The TGA analysis was conducted up to 900° C. under an inert environment using N₂. The samples lost their mass with an increase in temperature. The TGA analysis provides a step curve for all the samples. The mass loss varies with changes in temperature. The precipitates resulting from the high pH solution showed the highest thermal stability with approximately 50% weight loss at 900° C. The step curves showed the decomposition of samples with temperature. The mass loss occurred after 600° C. showed the decomposition of CaCO₃ into CaO and CO₂. The decomposition before 600° C. could be due to the decomposition of other reaction products formed during precipitation reaction. The mass loss below 200° C. is due to water dehydration from the sample. The thermal stability of the precipitations showed that the reaction products obtained from all the solutions do not degrade at high temperature conditions of the reservoirs (<200° C.). On other hand, the higher thermal stability was observed for the reaction products obtained from solution prepared with 1 M KOH which resulted in less mass loss compared to all other precipitated products.

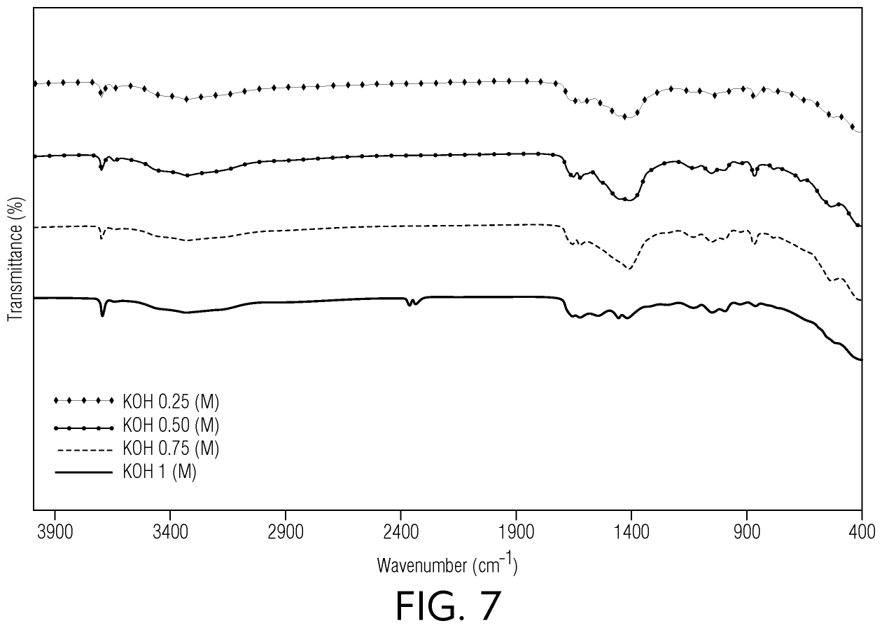

FTIR (Fourier transform infrared spectroscopy) can be used to analyze the reaction product formed by EICP. It determines the chemical composition and functional groups present in the reaction product as FIG. 7 shows the FTIR of reaction products resulting from precipitation tests performed on different pH solutions. In EICP, calcite or dolomite are formed by the reaction between Ca/Mg ions and carbonate ions produced from the hydrolysis of urea catalyzed by the urease enzyme. The FTIR spectrum of reaction products typically exhibits several characteristic absorption peaks. The most prominent peak is at around 1,400 cm⁻¹, which corresponds to the asymmetric stretching vibration of the carbonate (CO₃) group. Another peak is observed at around 870 cm⁻¹, which corresponds to the bending vibration of the carbonate group. Additionally, the FTIR spectrum can also reveal the presence of other functional groups or impurities that may be present in the calcite product. In addition to these peaks, dolomite also exhibits peaks at around 1,040 cm⁻¹, which correspond to the symmetric stretching and bending vibrations of the carbonate group. FTIR analysis can also be used to monitor the EICP process in real time. By analyzing the FTIR spectra of the reaction mixture at various stages of the process, it is possible to track the formation and growth of calcite crystals as well as the consumption of urea and the production of ammonium ions.

The composition of the reaction products formed during an enzymatic reaction was determined by XRD analysis. The results showed that the sample containing urea 1 M, 0.6 M CaCl₂, 0.4 M MgCl₂, 15% alpha amylase enzyme, and 0.5 M KOH had the highest percentage (53.3%) of dolomite (CaMg(CO₃)₂ and sylvite (42.6%) with a minor concentration of calcite. On the other hand, the sample containing 1 M urea, 0.6 M CaCl₂, 0.4 M MgCl₂, 15% alpha amylase enzyme, and 1 M KOH had 29% of calcite (CaCO₃), 4.8% dolomite, 7.8% aragonite, and 58.1% sylvite. The sample with 0.75 M KOH showed negligible amounts of both dolomite and calcite. Table 5 provides a detailed explanation of the different reaction products formed during the reaction.

TABLE 5
XRD analysis for the effect of increasing pH with
KOH for a sample consisting of 1M urea, 0.6M CaCl2, 0.4M
MgCl₂ and 15 wt % alpha amylase enzyme.

| KOH (M) | Calcite (%) | Dolomite (%) | Aragonite (%) | Sylvite (%) |
|---|---|---|---|---|
| 0.5 | 3 | 53.3 | 1.1 | 42.6 |
| 0.75 | 16.6 | 1.2 | 1.1 | 81.1 |
| 1 | 29.3 | 4.8 | 7.8 | 58.1 |

The results show that a 15% alpha amylase enzyme concentration yielded the highest precipitate. The best molar ratio combination for CaCl₂ and MgCl₂ was (0.6:0.4) for the highest CaCO₃ precipitation (32.2%). Alpha amylase enzyme volume in the solution did not significantly affect precipitation at a specific molar ratio. pH significantly affected precipitation; the precipitation yield increased with an increase in pH. The highest precipitate (87%) was obtained at 75° C. with 2.5 g/L xanthan gum as a stabilizer. The temperature affects the enzyme activity and 75° C. was found to be an effective temperature limit for the tested alpha amylase enzyme. TGA analysis revealed that the precipitated samples remained stable at temperatures and showed the reaction product was composed of CaCO₃ and other complexes as decomposition occurred at 600° C. XRD analysis showed that the sample consisting of 1 M urea, 0.6 M CaCl₂, 0.4 M MgCl₂, 15 wt % enzyme, and 0.5 M KOH had the largest proportion of dolomite (53%). In contrast, the sample consisting of 1 M urea, 0.6 M CaCl₂, 0.4 M MgCl₂, 15 wt % alpha amylase enzyme, and 1 M KOH showed 29% calcite and 4.8% dolomite.

### Example 2

A sample comprising 1 M urea, 0.6 M of CaCl₂, 0.6 M of MgCl₂ and 15 wt % alpha amylase enzyme concentration was prepared. This sample was injected into a sand pack coreflooding system operating at 100° C. The sand pack had 30 cm³ of loose sand with a pore volume of 10 cm³. The injection rate was 0.1 cm³/min and injection was carried out for an hour 1 hour to allow the maximum precipitation of the cementing materials. After the hour had elapsed, consolidated sand was extracted from the holder.

The present disclosure includes numerous aspects, referred to as Aspects 1-20, as described hereinbelow.

Aspect 1. A method for stabilizing a subterranean formation, the method comprising introducing urea into a subterranean formation, wherein the subterranean formation comprises sand, and wherein the subterranean formation comprises a calcium salt, and introducing an amylase into the subterranean formation, wherein the amylase hydrolyzes the urea to form ammonium carbonate, and calcium in the calcium salt reacts with carbonate in the ammonium carbonate to form a calcium carbonate precipitate.

Aspect 2. The method of aspect 1, wherein one or both of: the method further comprises introducing the calcium salt into the subterranean formation; and the calcium salt is naturally occurring in the subterranean formation.

Aspect 3. The method of aspect 1 or aspect 2, further comprising introducing the calcium salt into the subterranean formation.

Aspect 4. The method of any one of aspects 1-3, further comprising extracting hydrocarbons from the subterranean formation.

Aspect 5. The method of any one of aspects 1-4, wherein the amylase is chosen from alpha amylase, beta amylase, glucoamylase, oligo-1,6-glucosidase, alpha glucosidase, amylo-1,6-glucosidase, pullulanase, cyclomaltodextrinase, glucan-1,4-α-maltotetraohydrolase, isoamylase, glucan-1,4-alpha-maltohexaohydrolase, glucan-1,4-alpha-maltotriohydrolase, glucan-1,4-alpha-maltohydrolase, neopullulanase, 4-alpha-D-glucanotrehalosetrehalohydrolase, branching enzyme, cyclomaltodextringlucanotransferase, 4-alpha-glucanotransferase, and 4-alpha-glucan 1-alpha-D-glucosylmutase.

Aspect 6. The method of any one of aspects 1-5, wherein the amylase is alpha amylase.

Aspect 7. The method of any one of aspects 1-6, wherein the calcium salt is calcium chloride.

Aspect 8. The method of any one of aspects 1-7, wherein the subterranean formation further comprises a magnesium salt.

Aspect 9. The method of any one of aspects 1-8, wherein the magnesium salt is magnesium chloride.

Aspect 10. The method of any one of aspects 1-9, wherein a ratio of calcium salt to magnesium salt is from 1:1 to 2:1.

Aspect 11. The method of any one of aspects 1-10, wherein the subterranean formation has a basic pH.

Aspect 12. The method of any one of aspect 1-11, wherein the pH is from 11 to 13.

Aspect 13. The method of any one of aspect 1-12, wherein the method occurs at a temperature of from 0° C. to 100° C.

Aspect 14. The method of any one of aspect 1-13, wherein the method further comprises introducing xanthan gum into the subterranean formation.

Aspect 15. The method of any one of claims 1-14, wherein the xanthan gum has a concentration of from 2 g/L to 3 g/L in the subterranean formation.

Aspect 16. The method of any one of claims 1-15, wherein the amylase is introduced in a solution comprising from 10 wt. % to 20 wt. % amylase based on the total weight of the solution.

Aspect 17. The method of any one of claims 1-16 wherein the calcium salt is selected from calcium chloride, calcium nitrate, and combinations thereof.

Aspect 18. The method of any one of claims 1-17, wherein the ratio of urea to calcium salt is from 1:1 to 10:1.

Aspect 19. The method of any one of claims 1-18, wherein the calcium carbonate precipitate comprises calcite, aragonite, sylvite, or combinations thereof.

Aspect 20. The method of any one of claims 1-19, wherein calcium carbonate precipitate further comprises dolomite.

Having described the subject matter of the present disclosure in detail and by reference to specific embodiments, it is noted that the various details described in this disclosure should not be taken to imply that these details relate to elements that are essential components of the various embodiments described in this disclosure, even in cases where a particular element is illustrated in each of the drawings that accompany the present description. Rather, the claims infra should be taken as the sole representation of the breadth of the present disclosure and the corresponding scope of the various embodiments described in this disclosure. Further, it should be apparent to those skilled in the art that various modifications and variations can be made to the described embodiments without departing from the spirit and scope of the claimed subject matter. Thus it is intended that the specification cover the modifications and variations of the various described embodiments provided such modification and variations come within the scope of the claims recited infra and their equivalents.

It should be understood that any two quantitative values assigned to a property may constitute a range of that property, and all combinations of ranges formed from all stated quantitative values of a given property are contemplated in this disclosure. It should be appreciated that compositional ranges of a chemical constituent in a composition or formulation should be appreciated as containing, in some embodiments, a mixture of isomers of that constituent. It should be appreciated that the examples supply compositional ranges for various compositions, and that the total amount of isomers of a particular chemical composition can constitute a range.

Having described the subject matter of the present disclosure in detail and by reference to specific embodiments, it is noted that the various details described in this disclosure should not be taken to imply that these details relate to elements that are essential components of the various embodiments described in this disclosure, even in cases where a particular element is illustrated in each of the drawings that accompany the present description. Rather, the claims appended hereto should be taken as the sole representation of the breadth of the present disclosure and the corresponding scope of the various embodiments described in this disclosure. Further, it should be apparent to those skilled in the art that various modifications and variations can be made to the described embodiments without departing from the spirit and scope of the claimed subject matter. Thus it is intended that the specification cover the modifications and variations of the various described embodiments provided such modification and variations come within the scope of the appended claims and their equivalents.

As used in the Specification and appended Claims, the singular forms “a”, “an”, and “the” include plural references unless the context clearly indicates otherwise. The verb “comprises” and its conjugated forms should be interpreted as referring to elements, components or steps in a non-exclusive manner. The referenced elements, components or steps may be present, utilized or combined with other elements, components or steps not expressly referenced.

Where a range of values is provided in the Specification or in the appended Claims, it is understood that the interval encompasses each intervening value between the upper limit and the lower limit as well as the upper limit and the lower limit. The present disclosure encompasses and bounds smaller ranges of the interval subject to any specific exclusion provided.

What is claimed is:

1. A method for stabilizing a subterranean formation, the method comprising:
introducing urea into a subterranean formation, wherein the subterranean formation comprises sand, and wherein the subterranean formation comprises a calcium salt; and
introducing an amylase into the subterranean formation, wherein the amylase hydrolyzes the urea to form ammonium carbonate, and calcium in the calcium salt reacts with carbonate in the ammonium carbonate to form a calcium carbonate precipitate.

2. The method of claim 1, wherein one or both of:
the method further comprises introducing the calcium salt into the subterranean formation; and
the calcium salt is naturally occurring in the subterranean formation.

3. The method of claim 1, further comprising introducing the calcium salt into the subterranean formation.

4. The method of claim 1, further comprising extracting hydrocarbons from the subterranean formation.

5. The method of claim 1, wherein the amylase is chosen from alpha amylase, beta amylase, glucoamylase, oligo-1,6-glucosidase, alpha glucosidase, amylo-1,6-glucosidase, pullulanase, cyclomaltodextrinase, glucan-1,4-α-maltotetraohydrolase, isoamylase, glucan-1,4-alpha-maltohexaohydrolase, glucan-1,4-alpha-maltotriohydrolase, glucan-1,4-alpha-maltohydrolase, neopullulanase, 4-alpha-D-glucanotrehalosetrehalohydrolase, branching enzyme, cyclomaltodextringlucanotransferase, 4-alpha-glucanotransferase, and 4-alpha-glucan 1-alpha-D-glucosylmutase.

6. The method of claim 1, wherein the amylase is alpha amylase.

7. The method of claim 1, wherein the calcium salt is calcium chloride.

8. The method of claim 1, wherein the subterranean formation further comprises a magnesium salt.

9. The method of claim 8, wherein the magnesium salt is magnesium chloride.

10. The method of claim 8, wherein a ratio of calcium salt to magnesium salt is from 1:1 to 2:1.

11. The method of claim 1, wherein the subterranean formation has a basic pH.

12. The method of claim 11, wherein the pH is from 11 to 13.

13. The method of claim 1, wherein the method occurs at a temperature of from 0° C. to 100° C.

14. The method of claim 1, wherein the method further comprises introducing xanthan gum into the subterranean formation.

15. The method of claim 14, wherein the xanthan gum has a concentration of from 2 g/L to 3 g/L in the subterranean formation.

16. The method of claim 1, wherein the amylase is introduced in a solution comprising from 10 wt. % to 20 wt. % amylase based on the total weight of the solution.

17. The method of claim 1 wherein the calcium salt is selected from calcium chloride, calcium nitrate, and combinations thereof.

18. The method of claim 1, wherein the ratio of urea to calcium salt is from 1:1 to 10:1.

19. The method of claim 1, wherein the calcium carbonate precipitate comprises calcite, aragonite, sylvite, or combinations thereof.

20. The method of claim 19, wherein calcium carbonate precipitate further comprises dolomite.
